(19) United States
(12) Patent Application Publication
(10) Pub. No.: US 2025/0094803 A1
(43) Pub. Date: Mar. 20, 2025

(54) SYSTEMS AND METHODS FOR EFFICIENT TEST-TIME PREDICTION OF MODEL ARBITRARINESS

(71) Applicant: JPMORGAN CHASE BANK, N.A., New York, NY (US)

(72) Inventors: Hsiang HSU, Boston, MA (US); Richard CHEN, Baldwin Place, NY (US); Guihong LI, New York, NY (US)

(21) Appl. No.: 18/470,233

(22) Filed: Sep. 19, 2023

(51) Int. Cl. G06N 3/082

(52) U.S. Cl. CPC G06N 3/082

(57) ABSTRACT

Systems and methods for efficient test-time prediction of model arbitrariness are disclosed. According to an embodiment, a method for efficient test-time estimation of predictive multiplicity may include: (1) receiving, by arbitrariness prediction computer program, a trained machine learning model, wherein the trained machine learning model comprises a plurality of nodes, and each node has a weight; (2) determining, by the arbitrariness prediction computer program, a number of dropout models for the trained machine learning model to generate; (3) creating, by the arbitrariness prediction computer program, the number of dropout models; (4) providing, by the arbitrariness prediction computer program, sample data to each of the dropout models; (5) receiving, by the arbitrariness prediction computer program, an output from each of the dropout models; and (6) determining, by the arbitrariness prediction computer program, an arbitrariness for the trained machine learning model based on the outputs.

### BACKGROUND OF THE INVENTION

### 1. Field of the Invention

Embodiments relate to systems and methods for efficient test-time prediction of model arbitrariness.

### 2. Description of the Related Art

Modern machine learning models are increasingly complicated in terms of network architecture and training procedures. For example, GPT-3, the state-of-the-art language model, has more than 175 billion parameters, and DALL-E 2, a text-prompted vision generator, has 3.5 billion parameters. These models are over-parameterized and are often trained in an underspecified manner, i.e., there are exponentially many distinct solutions that achieve statistically indistinguishable performances. Despite that these models achieve similar performances, and are equally likely to be deployed in reality, the predictions given by the models for a given sample could be uncertain and have high variance. The phenomenon where competing models assign conflicting predictions to individual samples is called “predictive multiplicity.”

Predictive multiplicity captures the potential individual-level harm introduced by an arbitrary choice of a single model. When such a model is used to support automated decision-making, it can lead to unjustified and systemic exclusion of individuals from critical opportunities. Accounting for predictive multiplicity is critical—an arbitrary choice of a single model may lead to an unwarranted restriction of opportunities, unexplainable discrimination, and unfairness to individuals.

Measuring predictive multiplicity has been gradually recognized as one of the key aspects of a model when reporting the performance of a model. There are several metrics proposed to measure predictive multiplicity among competing models. The estimation of these metrics is, however, either computationally heavy or relies on strong assumptions (e.g., linear) of the models. The core challenge is the full characterization of the set of competing models to estimate those predictive multiplicity metrics. When the hypothesis space is large (e.g., neural networks or deep tree-based models), the set of competing models is also very large, and is infeasible to be completely explored.

### SUMMARY OF THE INVENTION

Systems and methods for efficient test-time prediction of model arbitrariness are disclosed. According to an embodiment, a method for efficient test-time estimation of predictive multiplicity may include: (1) receiving, by arbitrariness prediction computer program, a trained machine learning model, wherein the trained machine learning model comprises a plurality of nodes, and each node has a weight; (2) determining, by the arbitrariness prediction computer program, a number of dropout models for the trained machine learning model to generate; (3) creating, by the arbitrariness prediction computer program, the number of dropout models; (4) providing, by the arbitrariness prediction computer program, sample data to each of the dropout models; (5) receiving, by the arbitrariness prediction computer program, an output from each of the dropout models; and (6) determining, by the arbitrariness prediction computer program, an arbitrariness for the trained machine learning model based on the outputs.

In one embodiment, wherein the trained machine learning model may include a neural network.

In one embodiment, the number of dropout models to generate may be received as a parameter.

In one embodiment, the step of creating the number of dropout models may include removing, by the arbitrariness prediction computer program, a number or percentage of the plurality of nodes from each of the dropout models.

In one embodiment, the number or percentage of the plurality of nodes are removed by setting the weights for the number or percentage of the plurality of nodes to zero.

In one embodiment, the plurality of nodes to remove from each of the dropout models are randomly selected.

In one embodiment, the number or the percentage of nodes to remove may be received as a parameter.

In one embodiment, the step of creating the number of dropout models may include multiplying, by the arbitrariness prediction computer program, the weights for the plurality of nodes with Gaussian noise having a unit mean and a variance.

In one embodiment, the arbitrariness may be a ratio of outputs of the dropout models that are the same over the number of dropout models.

In one embodiment, the method may also include providing, by the arbitrariness prediction computer program, a second sample to the dropout models and receiving, by the arbitrariness prediction computer program, second outputs from each of the dropout models for the second sample, wherein the arbitrariness is based on the outputs and the second outputs.

According to another embodiment, a non-transitory computer readable storage medium may include instructions stored thereon, which when read and executed by one or more computer processors, cause the one or more computer processors to perform steps comprising: receiving a trained machine learning model, wherein the trained machine learning model comprises a plurality of nodes, and each node has a weight; determining a number of dropout models for the trained machine learning model to generate; creating the number of dropout models; providing sample data to each of the dropout models; receiving an output from each of the dropout models; and determining an arbitrariness for the trained machine learning model based on the outputs.

In one embodiment, the trained machine learning model may include a neural network.

In one embodiment, the number of dropout models to generate may be received as a parameter.

In one embodiment, the instructions may cause the one or more computer processors to create the number of dropout models by removing a number or percentage of the plurality of nodes from each of the dropout models.

In one embodiment, he instructions may cause the one or more computer processors to remove the number or percentage of the plurality of nodes by setting the weights for the number or percentage of the plurality of nodes to zero.

In one embodiment, the plurality of nodes to remove from each of the dropout models are randomly selected.

In one embodiment, the number or the percentage of nodes to remove may be received as a parameter.

In one embodiment, the instructions may cause the one or more computer processors to create the number of dropout models by multiplying the weights for the plurality of nodes with Gaussian noise having a unit mean and a variance.

In one embodiment, the arbitrariness may be a ratio of output of the dropout models that are the same over the number of dropout models.

In one embodiment, the non-transitory computer readable storage medium may also include instructions stored thereon, which when read and executed by one or more computer processors, cause the one or more computer processors to perform steps comprising providing a second sample to the dropout models and receiving second outputs from each of the dropout models for the second sample, wherein the arbitrariness is based on the outputs and the second outputs.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for efficient test-time prediction of model arbitrariness according to an embodiment;

FIG. 2 illustrates a method for efficient test-time prediction of model arbitrariness according to an embodiment; and

FIG. 3 depicts an exemplary computing system for implementing aspects of the present disclosure.

### DETAILED DESCRIPTION OF PREFERRED EMBODIMENTS

Embodiments relate to systems and methods for efficient test-time prediction of model arbitrariness.

Given a pre-trained model, embodiments may perform dropout on the some of the weights of the pre-trained model. For example, the dropout method may be Bernoulli dropout (i.e., certain weights are randomly removed) or Gaussian dropout (i.e., certain weights are multiplied with a Gaussian noise (e.g., noise with a Gaussian distribution) with a unit mean). Examples of Bernoulli dropouts are disclosed in Srivastava, N., Hinton, G., Krizhevsky, A., Sutskever, I., and Salakhutdinov, R. “Dropout: a simple way to prevent neural networks from overfitting,” The journal of machine learning research, 15 (1): 1929-1958 (2014), and Bernoulli dropouts and other types of dropouts are disclosed in Alex Labach, Hojjat Salehinejad, and Shahrokh Valaee, “Survey of dropout methods for deep neural networks” arXiv preprint arXiv: 1904.13310 (2019), the disclosures of which are hereby incorporated, by reference, in their entireties.

Embodiments may generate a set of dropout models for the pre-trained model, resulting in models that have outputs different from the original pre-trained model, and an average test performance similar to the original pre-trained model. The set of dropout models possess predictive multiplicity while achieving statistically indistinguishable performances, and can be used to efficiently estimate predictive multiplicity metrics.

Embodiments may provide at least some of the following technical advantages. Currently, predictive multiplicity metrics are approximated by repeatedly re-training and collecting competing models, which is resource and time consuming. The disclosed generation of dropout models from a pre-trained model does not involve any additional training, and thereby provides an efficient method for measuring predictive multiplicity.

In addition, instead of performing dropout at training time, given a pre-trained model, embodiments perform dropout at the test time, where each model after dropout forms a set of competing models. Because only the performance inference of the models is needed, the time needed to sample models from a Rashomon set of machine learning models (e.g., a set of machine learning models that have statistically indistinguishable performance) via re-training may be significantly reduced.

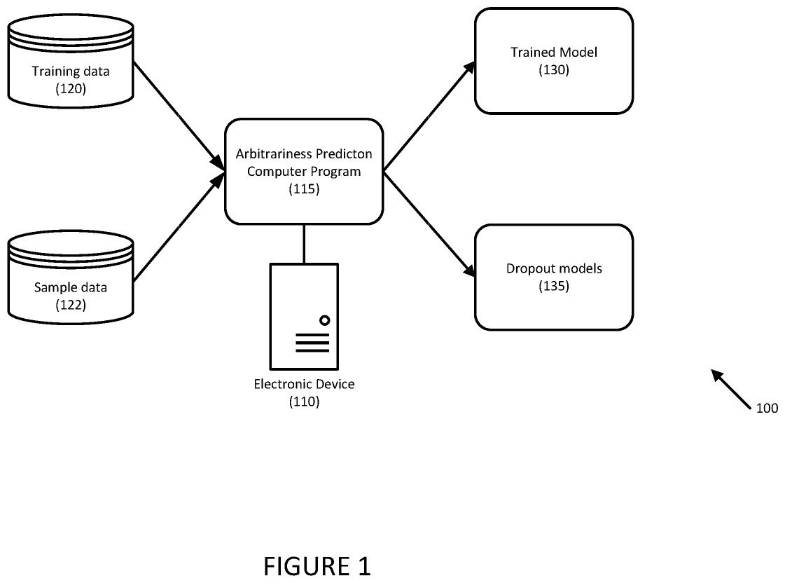

Referring to FIG. 1, a system for efficient test-time estimation of predictive multiplicity is disclosed according to an embodiment. System 100 may include electronic device 110, which may be a server (e.g., physical and/or cloud-based), computers (e.g., workstations, desktops, laptops, notebooks, tablets, etc.), smart devices, Internet of Things (IoT) appliances, etc. Electronic device 110 may execute arbitrariness prediction computer program 115, which may receive trained model 130 for analysis. Trained model 130 may be, for example, a neural network that may include a plurality of nodes, and each node may be associated with a weight. Trained model 130 may be trained with training data 120.

Arbitrariness prediction computer program 115 may generate a dropout models 135 by dropping out weights from trained model 130. The dropout method may be, for example, Bernoulli dropout, Gaussian dropout, or any other suitable dropout.

Arbitrariness prediction computer program 115 may provide sample data 122 to dropout models 135 and may monitor the output of the models (i.e., the predictions). It may then determine an arbitrariness prediction from, for example, a ratio of the number of results that are the same over the total number of sample runs.

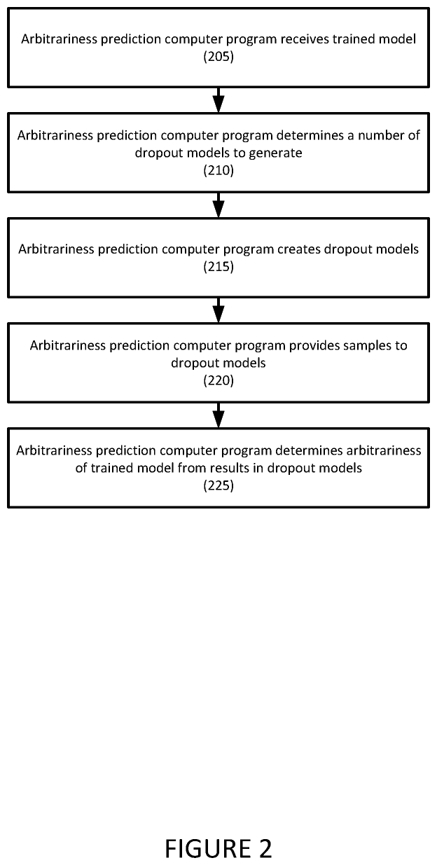

Referring to FIG. 2, a method for efficient test-time estimation of predictive multiplicity is disclosed according to an embodiment.

In step 205, a computer program, such as an arbitrariness prediction computer program, executed on an electronic device may receive a trained machine learning model, such as a neural network model. The trained machine learning model may include a plurality of nodes, and each node may be associated with a weight.

In step 210, the computer program may determine a number of dropout models to generate. In general, the greater the number of dropout models, the better the estimate of arbitrariness. Thus, the number of dropout models may be determined by the computational resource and time budget available. For example, the number of dropout models to generate may be received as a parameter.

In step 215, the computer program may create dropout models with Bernoulli dropouts or Gaussian dropouts. For Bernoulli dropouts, the computer program may determine a number or a percentage of the nodes to remove from the trained machine learning model. The percentage or number of nodes to dropout may be a tunable parameter. For example, a parameter search may be used to identify the number or percentage of nodes to remove that is suitable for the application.

The computer program may then randomly select nodes in the trained machine learning model to remove based on the number or percentage of nodes to dropout. In one embodiment, the computer program may set the weights for the selected nodes to zero.

For Gaussian dropouts, the computer program may multiply the weights for the plurality of nodes with a Gaussian noise having a unit mean (e.g., the value of the mean is 1) and a variance, which is tunable. The mean controls the offset value of the Gaussian noise, and the variance controls the spread of the values. If the variance is 0, then a Gaussian distribution is a constant with its mean 1. If the variance is high, the values of a Gaussian noise will be more chaotic.

Examples of Gaussian noise dropout are disclosed in Kingma, D. P., Salimans, T., and Welling, M., “Variational dropout and the local reparameterization trick,” Advances in neural information processing systems, 28 (2015) and Wang, S., and Manning, C . . . “Fast dropout training,” Proceedings of the 30th International Conference on Machine Learning, PMLR 28(2):118-126 (2013), the disclosures of which are hereby incorporated, by reference, in their entireties.

In one embodiment, both dropouts may be tried and the results reviewed to determine the dropout that gives the best accuracy.

The computer program may then repeat the process to generate the number of dropout models selected.

In step 220, the computer program may provide sample data to dropout models for the dropout models to execute, and may monitor the output (i.e., the prediction) from each dropout model. For example, the sample data may be based on the training for the trained machine learning model. For example, if the trained machine learning model is trained for image recognition, the sample data may be image data. If the trained machine learning model is trained for tabular data, the sample data may be tabular data.

In step 225, the computer program may determine an arbitrariness of the trained model from the outputs of the dropout models based on a ratio of the number of dropout models that provide the same output over the total number of dropout models. For example, if there are 10,000 dropout models, and 9,700 have the same output (and 300 have different outputs), the arbitrariness of the trained machine learning model is 97%.

The arbitrariness may be based on one sample or a plurality of samples.

Embodiments may be used to assess multiple trained machine learning models, and the a majority decision may be used to select the best model to use.

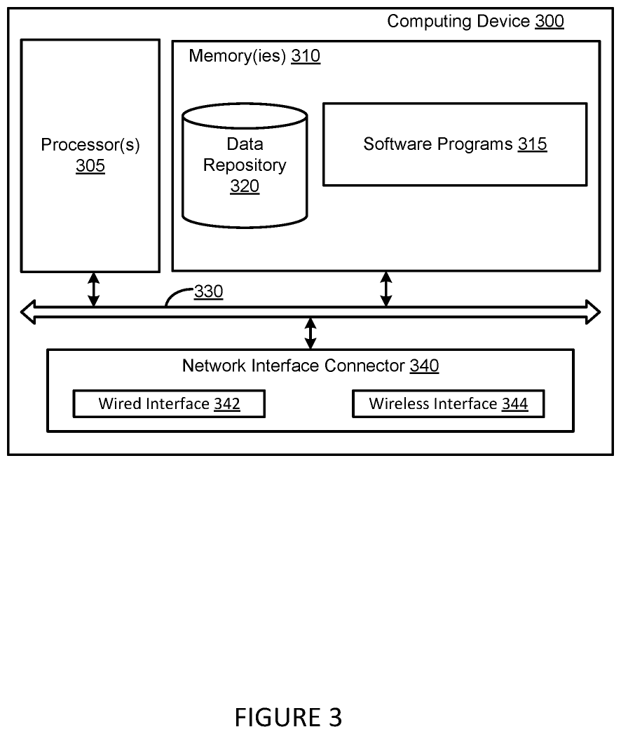

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for efficient test-time estimation of predictive multiplicity, comprising:
receiving, by arbitrariness prediction computer program, a trained machine learning model, wherein the trained machine learning model comprises a plurality of nodes, and each node has a weight;
determining, by the arbitrariness prediction computer program, a number of dropout models for the trained machine learning model to generate;
creating, by the arbitrariness prediction computer program, the number of dropout models;
providing, by the arbitrariness prediction computer program, sample data to each of the dropout models;
receiving, by the arbitrariness prediction computer program, an output from each of the dropout models; and
determining, by the arbitrariness prediction computer program, an arbitrariness for the trained machine learning model based on the outputs.

2. The method of claim 1, wherein the trained machine learning model comprises a neural network.

3. The method of claim 1, wherein the number of dropout models to generate is received as a parameter.

4. The method of claim 1, wherein the step of creating the number of dropout models comprises:
removing, by the arbitrariness prediction computer program, a number or percentage of the plurality of nodes from each of the dropout models.

5. The method of claim 4, wherein the number or percentage of the plurality of nodes are removed by setting the weights for the number or percentage of the plurality of nodes to zero.

6. The method of claim 4, wherein the plurality of nodes to remove from each of the dropout models are randomly selected.

7. The method of claim 4, wherein the number or the percentage of nodes to remove is received as a parameter.

8. The method of claim 1, wherein the step of creating the number of dropout models comprises:
multiplying, by the arbitrariness prediction computer program, the weights for the plurality of nodes with Gaussian noise having a unit mean and a variance.

9. The method of claim 1, wherein the arbitrariness is a ratio of outputs of the dropout models that are the same over the number of dropout models.

10. The method of claim 1, further comprising:
providing, by the arbitrariness prediction computer program, a second sample to the dropout models; and
receiving, by the arbitrariness prediction computer program, second outputs from each of the dropout models for the second sample;
wherein the arbitrariness is based on the outputs and the second outputs.

11. A non-transitory computer readable storage medium, including instructions stored thereon, which when read and executed by one or more computer processors, cause the one or more computer processors to perform steps comprising:
receiving a trained machine learning model, wherein the trained machine learning model comprises a plurality of nodes, and each node has a weight;
determining a number of dropout models for the trained machine learning model to generate;
creating the number of dropout models;
providing sample data to each of the dropout models;
receiving an output from each of the dropout models; and
determining an arbitrariness for the trained machine learning model based on the outputs.

12. The non-transitory computer readable storage medium of claim 11, wherein the trained machine learning model comprises a neural network.

13. The non-transitory computer readable storage medium of claim 11, wherein the number of dropout models to generate is received as a parameter.

14. The non-transitory computer readable storage medium of claim 11, wherein, when read and executed by one or more computer processors, the instructions cause the one or more computer processors to create the number of dropout models by removing a number or percentage of the plurality of nodes from each of the dropout models.

15. The non-transitory computer readable storage medium of claim 14, wherein, when read and executed by one or more computer processors, the instructions cause the one or more computer processors to remove the number or percentage of the plurality of nodes by setting the weights for the number or percentage of the plurality of nodes to zero.

16. The non-transitory computer readable storage medium of claim 14, wherein the plurality of nodes to remove from each of the dropout models are randomly selected.

17. The non-transitory computer readable storage medium of claim 14, wherein the number or the percentage of nodes to remove is received as a parameter.

18. The non-transitory computer readable storage medium of claim 11, wherein, when read and executed by one or more computer processors, the instructions cause the one or more computer processors to create the number of dropout models by multiplying the weights for the plurality of nodes with Gaussian noise having a unit mean and a variance.

19. The non-transitory computer readable storage medium of claim 11, wherein the arbitrariness is a ratio of output of the dropout models that are the same over the number of dropout models.

20. The non-transitory computer readable storage medium of claim 11, further including instructions stored thereon, which when read and executed by one or more computer processors, cause the one or more computer processors to perform steps comprising:
providing a second sample to the dropout models; and
receiving second outputs from each of the dropout models for the second sample;
wherein the arbitrariness is based on the outputs and the second outputs.
